(19) United States
(12) Patent Application Publication
(10) Pub. No.: US 2024/0069255 A1
(43) Pub. Date: Feb. 29, 2024

(54) MICROLENS ARRAY, DIFFUSION PLATE, AND ILLUMINATION DEVICE

(71) Applicant: Daicel Corporation, Osaka (JP)

(72) Inventors: Makoto Yasuhara, Tokyo (JP); Maki Kishimoto, Tokyo (JP)

(73) Assignee: Daicel Corporation, Osaka (JP)

(21) Appl. No.: 18/270,064

(22) PCT Filed: Dec. 20, 2021
(86) PCT No.: PCT/JP2021/046990

§ 371 Date: Jun. 28, 2023

(30) Foreign Application Priority Data
Dec. 28, 2020 (JP) 2020-219703

(51) Int. Cl. G02B 5/02; G01S 7/481; G02B 3/00; G02B 3/04

(52) U.S. Cl. CPC G02B 5/0278; G01S 7/4814; G02B 3/0056; G02B 3/04; G02B 5/0205

(57) ABSTRACT

A technique with which a more uniform irradiance distribution can be more reliably obtained than before is provided. A micro lens array includes: a plurality of lens elements arrayed on at least one surface of a planar member. A shape of a lens surface in each of the lens elements is defined by an aspherical expression. A pitch D between the lens elements in the micro lens array is 25 μm or greater and 150 μm or less. An intensity distribution of light that passes through the micro lens array has a batwing intensity distribution in which light intensity at both ends in a predetermined range of an angle of view is maximized and light intensity at the center in the range of the angle of view is minimized.

### CROSS-REFERENCE TO RELATED APPLICATION

This patent application is a national phase application of International patent application No. PCT/JP2021/046990, filed on Dec. 20, 2021 which claims the benefit of priority of the prior Japanese Patent Application No. 2020-219703, filed on Dec. 28, 2020, the entire contents of which are incorporated herein by reference.

### TECHNICAL FIELD

The present invention relates to a micro lens array, a diffuser plate, and an illumination apparatus.

### BACKGROUND ART

For example, a known micro lens array has a plurality of lens elements arrayed and is used for an apparatus for illumination, measurement, facial recognition, spatial recognition, and the like (see for example, Patent Literatures 1 and 2). When such a micro lens array is used for the purpose of optically making light from a light source uniform, and if a pitch between the lens elements is too small, interference fringes due to interference of light transmitted between the lens elements become obvious and may hinder the uniformity of light-source light. On the other hand, when the pitch between the lens elements is too great, moire fringes are generated, which may also prevent the light source from being made uniform. As a result, when a screen or the like is irradiated with the light-source light using the micro lens array, irradiance distribution may be non-uniform.

To suppress the above-described non-uniformity of the irradiance distribution due to the interference fringes and the moire fringes, a measure is devised that the positions, the shapes, and the like of the lens elements distributed are randomized (for example, see Patent Literatures 3 to 5). Unfortunately, excessive randomization may not provide desired light distribution characteristics, and in particular, may make it difficult to sharpen an edge of an irradiation profile. Furthermore, a complicated array of the lens elements may cause disadvantages such as a long production time and a high production cost.

In some of the above-described known techniques, it is sufficient to obtain a uniform irradiance distribution in a range of about ±10°. However, in recent years, the number of cases where a micro lens array is used in distance measuring equipment or the like has increased, and in some of these cases, a uniform irradiance distribution over a wide range on a measurement target has been required. To obtain a uniform irradiance distribution over a wide range on the measurement target, it is necessary to ensure a greater amount of light in the wide angle region. Note that examples of distance measuring equipment using a micro lens array include distance measuring equipment using a Time Of Flight (TOF) system and the like.

### CITATION LIST

### Patent Document

Patent Document 1: WO 2005/103795
Patent Document 2: WO 2015/182619
Patent Document 3: US 2004/0130790 A
Patent Document 4: JP 2020-067664 A
Patent Document 5: WO 2016/143350 A

### SUMMARY OF INVENTION

### Technical Problem

The technique of the present disclosure is invented in view of the above, and an object thereof is to provide a technique with which a more uniform irradiance distribution can be obtained in a wider angle range than before using a micro lens array.

### Solution to Problem

To solve the problem described above, a micro lens array according to the present disclosure includes: a plurality of lens elements arrayed on at least one surface of a planar member, wherein a shape of a lens surface in each of the lens elements is defined by an aspherical expression, a pitch D between the lens elements in the micro lens array is 25 μm or greater and 150 μm or less, and an intensity distribution of light that passes through the micro lens array has a batwing intensity distribution in which light intensity at both ends in a predetermined range of an angle of view is maximized and light intensity at the center in the range of the angle of view is minimized.

In this way, the irradiance distribution of the light that has passed through the micro lens array can be made more uniform in the predetermined range of the angle of view. Further, the appearance of interference fringes and moire fringes can be suppressed in the irradiance distribution. Note that the predetermined range of the angle of view described above is a range of an angle of view set in advance according to the intended use of the micro lens array.

Further, the batwing intensity distribution may have a distribution characteristic along a curve of COS⁻ⁿθ (n=0 to 10) for an angle θ of the lens element with respect to an optical axis direction. In this way, the irradiance distribution of the light that has passed through the micro lens array can reliably be made more uniform in the predetermined range of the angle of view. Note that a range of n may be more preferably n=1 to 7.

Further, a radius R at an apex of the lens element may be 3 μm or greater and 60 μm or less. By setting the radius R at the apex of each of the lens elements to 60 μm or less and setting θ at the base of the lens element to about 75°, for example, the irradiance distribution of light that has passed through the micro lens array can be made sufficiently uniform in a wide angle region exceeding ±50°.

Further, a radius R at an apex of the lens element, a pitch D between the lens elements, and an angle θ of the lens element with respect to an optical axis direction may have a relationship of D/R/COS⁻ⁿθ=1.5±25%.

In this way, the irradiance distribution of the light that has passed through the micro lens array can be further reliably made more uniform in the predetermined range of the angle of view.

Further, a sag amount Z in the lens element may satisfy

$$[ Math . 1 ]$$

$$Z = \frac{{C}_{X} {X}^{2} + {C}_{Y} {Y}^{2}}{1 + \sqrt{1 - ( 1 + {K}_{X} ) {C}_{X}^{2} {X}^{2} - ( 1 + {K}_{Y} ) {C}_{Y}^{2} {Y}^{2}}} + {\sum }_{n = 2}^{10} {{A}_{2 n} [ ( 1 - {B}_{2 n} ) {X}^{2} + ( 1 + {B}_{2 n} ) {Y}^{2} ]}^{n}$$

where C_{X} and C_{Y} are curvatures (C=1/R) in the X and Y directions at the apex of each of the lens elements 1a, K_{X} and K_{Y} are conic coefficients in the X and Y directions (X and Y are X and Y coordinates in orthogonal coordinates with the optical axis of each of the lens elements 1a as the origin), A₂ₙ and B₂ₙ are coefficients, and n is an integer.

Further, a randomization rate of the plurality of lens elements may be ±20% or less.

Further, the micro lens array may be formed integrally of a same material.

A diffuser plate may be formed using the micro lens array described above.

An illumination apparatus may be formed by the micro lens array described above and a light source that emits light incident on the micro lens array.

In the illumination apparatus described above, the lens elements of the micro lens array may be arrayed on a surface on a side close to the light source.

Further, the directivity of the light source in the illumination apparatus may be ±20° or less. When the light source with high directivity is used, the irradiance distribution at both ends of the angle of view can be shaped to be more edgy.

The light source may be a laser light source that emits near-infrared light.

The illumination apparatus described above may be used in distance measuring equipment using a Time Of Flight system.

Note that, in the present invention, wherever possible, the techniques for solving the above-described problem can be used in combination.

### Advantageous Effects of Invention

According to the present disclosure, a more uniform irradiance distribution can be obtained in a wider angle range than before using a micro lens array.

### BRIEF DESCRIPTION OF DRAWINGS

FIG. 1 is a diagram illustrating a schematic configuration of distance measuring equipment using a Time Of Flight system.

FIG. 2 is a diagram illustrating an evaluation system in which a screen is irradiated with light emitted from a light source and transmitted through a micro lens array.

FIG. 3 is an enlarged view illustrating a cross section of the micro lens array.

FIGS. 4A-4C are examples of an irradiance distribution on the screen obtained in the evaluation system.

FIGS. 5A-5B are diagrams illustrating a difference in the irradiance distribution of the micro lens array depending on the presence or absence of randomization.

FIG. 6 is an example of a batwing intensity distribution of light that has passed through the micro lens array.

FIG. 7 shows an example of the irradiance distribution on the screen of the light that has passed through the micro lens array.

FIG. 8 is a diagram showing an example of a relationship between an angle of view θ_{FOI} and a pitch D/radius R.

FIG. 9 is a diagram showing an example of a relationship between the pitch D, the radius R, and COS⁻ⁿθ.

FIG. 10 is a perspective view of a diffuser plate obtained by forming the micro lens array on a surface of a flexible sheet.

FIG. 11 is a diagram illustrating a schematic configuration of an illumination apparatus.

### DESCRIPTION OF EMBODIMENTS

A micro lens array according to an embodiment of the present disclosure will be described below with reference to the drawings. Note that each of the configurations, combinations thereof, and the like in the embodiment are an example, and various additions, omissions, substitutions, and other changes may be made as appropriate without departing from the spirit of the present disclosure. The present disclosure is not limited by the embodiment and is limited only by the claims.

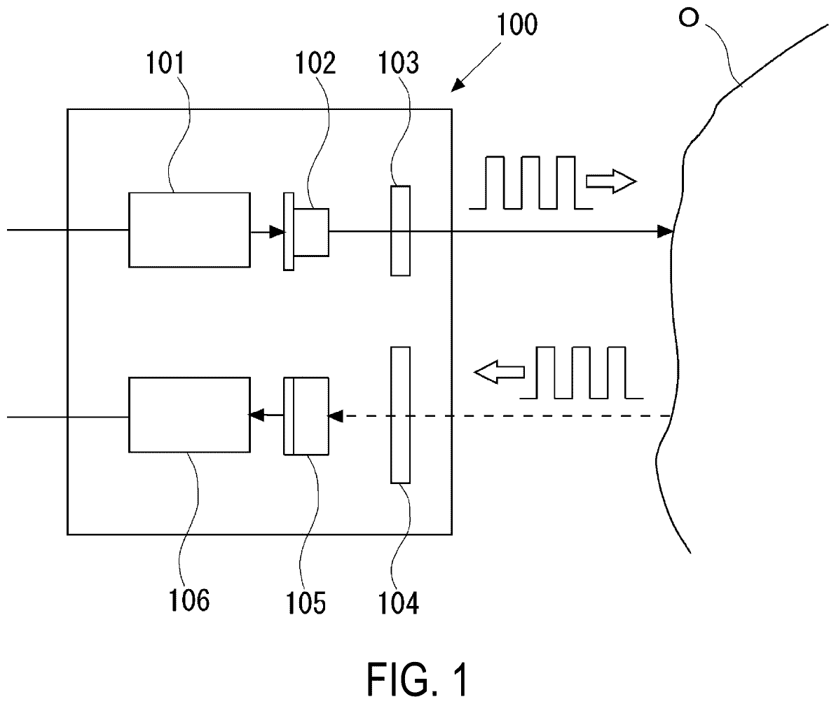

FIG. 1 is a schematic view illustrating distance measuring equipment 100 using a Time Of Flight (TOF) system, as an example of an application of a micro lens array according to an embodiment. The distance measuring equipment 100 using the TOF system measures a distance to each part of a surface of a measurement target O by measuring time-of-flight of irradiation light, and includes a light source control unit 101, an irradiation light source 102, an irradiation optical system 103, a light receiving optical system 104 that collects reflected light from the measurement target O, a light receiving element 105, and a signal processing circuit 106.

When the irradiation light source 102 emits pulsed light based on a drive signal from the light source control unit 101, the pulsed light passes through the irradiation optical system 103 and is emitted onto the measurement target O. The reflected light reflected on the surface of the measurement target O passes through the light receiving optical system 104, is received by the light receiving element 105, and then is converted into an appropriate electrical signal by the signal processing circuit 106. Then, a calculation unit (not illustrated) measures the distance to each location on the measurement target O by measuring the time from when the irradiation light is irradiated from the irradiation light source 102 until the light receiving element 105 receives the reflected light, that is, the time of flight of the light.

For the irradiation optical system 103 or the light receiving optical system 104 in the distance measuring equipment 100 using the TOF system, a micro lens array may be used. The micro lens array is a lens array formed by the group consisting of micro lens elements having a diameter in a range of about 10 μm to several millimeters. The function and accuracy of the micro lens array vary depending on the shape (such as spherical, aspherical, cylindrical, or hexagonal) of each lens element constituting the lens array, the size of the lens element, the arrangement of the lens elements, the pitch between the lens elements and the like.

When the micro lens array is used for the distance measuring equipment 100 using the TOF system described above, the measurement target O is required to be irradiated with light with a uniform intensity distribution. That is, the angle of view θ_{FOI} (FOI: Field of Illumination) that is a usable divergence angle of light that has passed through the micro lens array is determined according to the size of the measurement target O or the measurement distance, but in the range of the angle of view θ_{FOI}, the uniformity of the irradiance distribution of the light that has passed through the micro lens array is required.

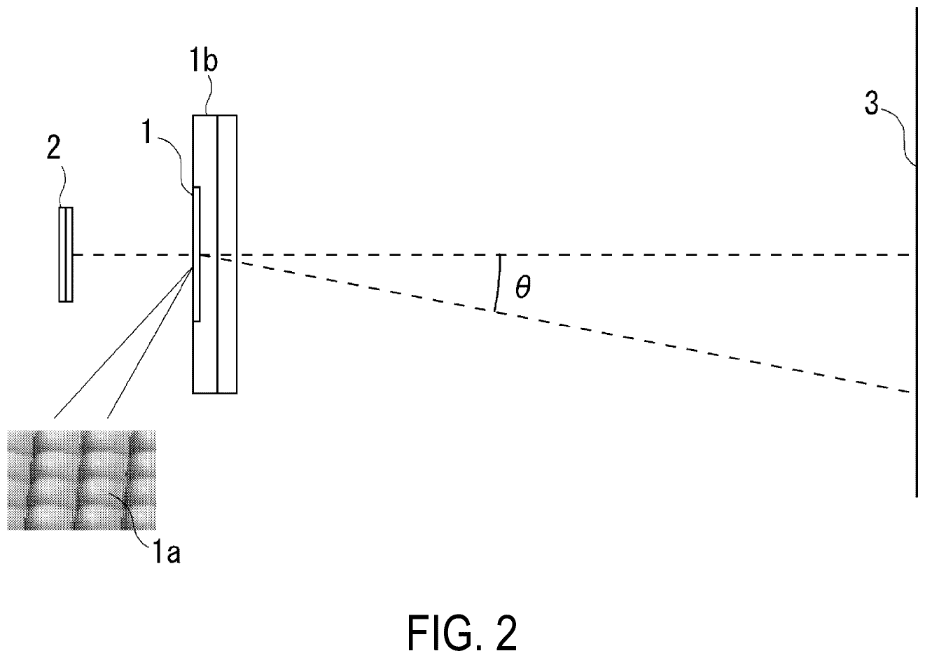

Next, a description will be given on an evaluation system in which a screen 3 is irradiated with light emitted from a light source 2 and passed through a micro lens array 1 as illustrated in FIG. 2. Here, the light source 2 is, for example, a vertical cavity surface emitting laser (VCSEL) light source, and the orientedness of the light source 2 can be selected from approximately ±5 degrees, ±10 degrees, and ±20 degrees. The micro lens array 1 formed by forming an array, in which lens elements 1a are two-dimensionally arrayed, is provided on one or both side surfaces of a base material 1b that is a planar member, and the light that has passed through the micro lens array 1 turns into diffused light that diffuses with respect to an optical axis, and is emitted onto the screen 3 simulating the measurement target O.

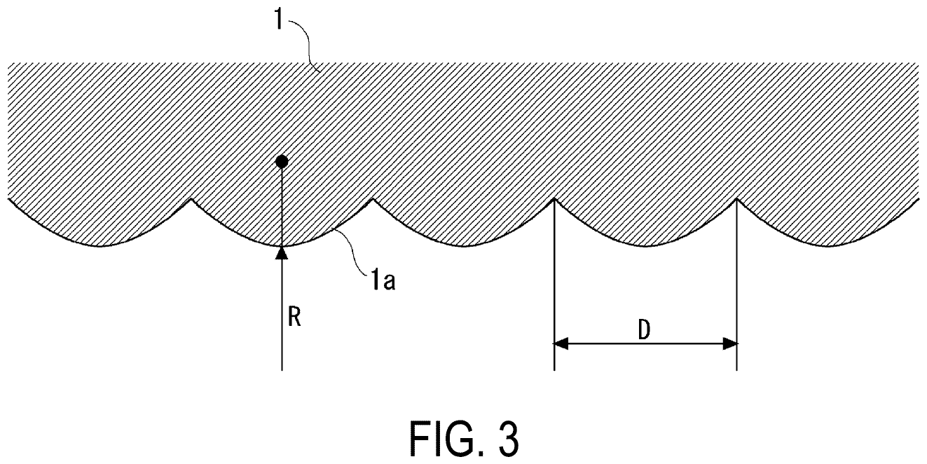

FIG. 3 is an enlarged cross-sectional view of the micro lens array 1. As illustrated in FIG. 3, the micro lens array 1 is basically characterized by the diameter R of each of the lens elements 1a and a distance (pitch) D between the lens elements. As a material of the micro lens array 1, a resin material or a glass material is used, but the material is not particularly limited.

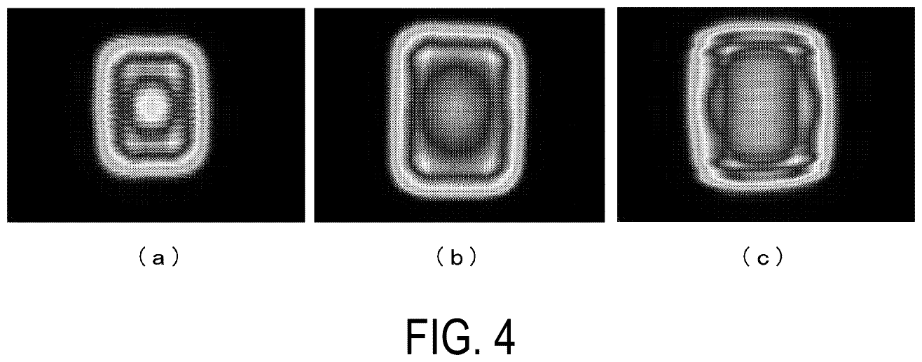

FIGS. 4A-4C illustrate examples of a profile of an irradiance distribution on the screen 3 obtained in the evaluation system as illustrated in FIG. 2. In FIGS. 4A-4C, FIGS. 4A, 4B, and 4C illustrate the irradiance distribution when the pitch D between the lens elements 1a of the micro lens array 1 is increased in this order. More specifically, for example, FIG. 4A illustrates a case where the pitch D is less than 25 μm, FIG. 4B illustrates a case where the pitch D is 25 μm or greater and 150 μm or less, and FIG. 4C illustrates a case where the pitch D is more than 150 μm.

As seen from the drawings, in the case of FIG. 4A, a striped pattern appears and the uniformity of the irradiance distribution is reduced. The reason is that the pitch D between the lens elements 1a of the micro lens array 1 is too small and an interval between the interference fringes formed by the light that has passed through the lens elements 1a becomes great, and thus the interference fringes become apparent. Also, in the case of FIG. 4C, a striped pattern appears and the uniformity of the irradiance distribution is reduced. The reason is that the pitch D between the lens elements 1a of the micro lens array 1 is too great and the moire fringes become apparent.

In this way, when the pitch D between the lens elements 1a in the micro lens array 1 is too great or too small, the uniformity of the irradiance distribution is reduced. In the related art, to suppress the appearance of such interference fringes and moire fringes, randomization (non-periodicity) has been performed in which shapes and positions of the lens elements 1a of the micro lens array 1 are intentionally randomly varied within a predetermined range. In other words, when the lens elements 1a are periodically arrayed, periodic interference fringes having uniform pitch and direction are more likely to occur due to the periodicity of the arrangement of the lens elements 1a. Thus, for example, optical axes of the lens elements 1a are randomly shifted to make the pitch irregular, thereby eliminating the periodicity of the arrangement of the lens elements 1a and suppressing the occurrence of the interference fringes.

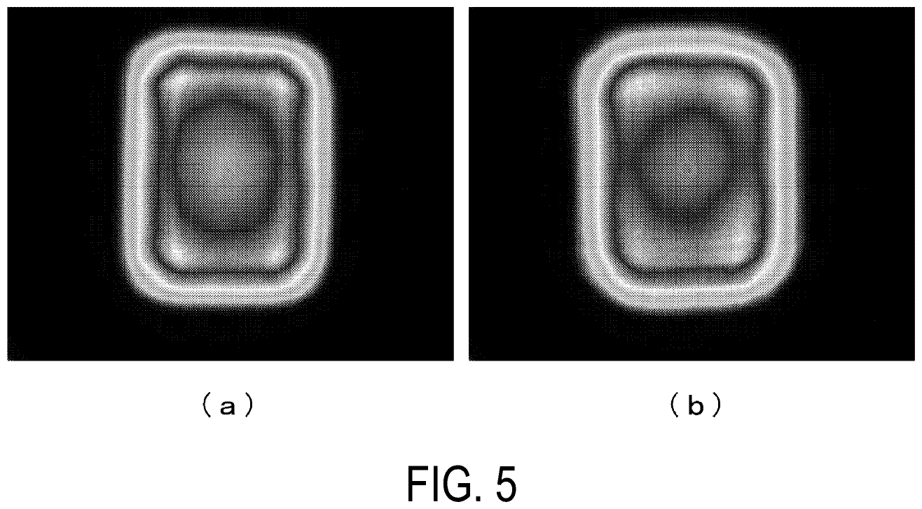

FIGS. 5A-5B are diagrams illustrating a difference in the irradiance distribution of the micro lens array 1 depending on the presence or absence of such randomization. FIG. 5A corresponds to a case without randomization, and FIG. 5B corresponds to a case with a randomization rate of 5%. It can be seen that a profile is blurred in FIG. 5B as compared with FIG. 5A. In this way, by performing randomization, the appearance of interference fringes and moire fringes can be suppressed, but, on the other hand, the profile of the irradiance distribution may become blurred. Here, the randomization rate is, for example, a value corresponding to ΔD/D when the design pitch D is irregularly varied within a range of ΔD.

To solve these inconveniences, in the present embodiment, the following requirements are incorporated into the specifications of the lens elements 1a in the micro lens array 1.

First, in the present embodiment, the lens surface of each of the lens elements 1a has an aspherical shape. In that case, the sag amount Z indicating a height of the lens surface of each of the lens elements 1a is defined by the following aspherical expression (1).

$$[ Math . 2 ]$$

$$Z = \frac{{C}_{X} {X}^{2} + {C}_{Y} {Y}^{2}}{1 + \sqrt{1 - ( 1 + {K}_{X} ) {C}_{X}^{2} {X}^{2} - ( 1 + {K}_{Y} ) {C}_{Y}^{2} {Y}^{2}}} + {\sum }_{n = 2}^{10} {{A}_{2 n} [ ( 1 - {B}_{2 n} ) {X}^{2} + ( 1 + {B}_{2 n} ) {Y}^{2} ]}^{n} \qquad ( 1 )$$

Note that C_{X} and C_{Y} are curvatures (C=1/R) in the X and Y directions at the apex of each of the lens elements 1a, K_{X} and K_{Y} are conic coefficients in the X and Y directions (X and Y are X and Y coordinates in orthogonal coordinates with the optical axis of each of the lens elements 1a as the origin), A₂ₙ and B₂ₙ are coefficients, and n is an integer.

Note that a shape of each of the lens elements 1a defined by the aspherical expression (1) may be point-symmetric with respect to the optical axis of each of the lens elements 1a, or may be asymmetric in the X direction and the Y direction. In the case of point symmetry with respect to the optical axis of each of the lens elements 1a, C_{X}=C_{Y} in the expression (1) is K_{X}=K_{Y}. In this case, the expression (1) can be described by a variable r=√(X²+Y²) instead of the variables X and Y.

When the shape of each of the lens elements 1a is asymmetric in the X direction and the Y direction, the radius R and the pitch D at the apex of each of the lens elements 1a are also different in the X direction and the Y direction, and R_{X}, R_{Y}, D_{X}, and D_{Y} are defined. If R_{X} or R_{Y} is ∞ (C_{X} or C_{Y}=0), the shape of each of the lens elements 1a is cylindrical.

Then, by adjusting each parameter in the mathematical expression (1), the intensity distribution of the light that has passed through the micro lens array 1 is made to have a so-called batwing intensity distribution in which the light intensity at both ends of the angle of view θ_{FOI} is maximized and the light intensity at the center of the angle of view θ_{FOI} is minimized. By causing the intensity distribution of the light that has passed through the micro lens array 1 to be the batwing intensity distribution, the irradiance distribution of the light that has passed through the micro lens array 1 in the range of the angle of view θ_{FOI} on the screen 3 can be made more uniform.

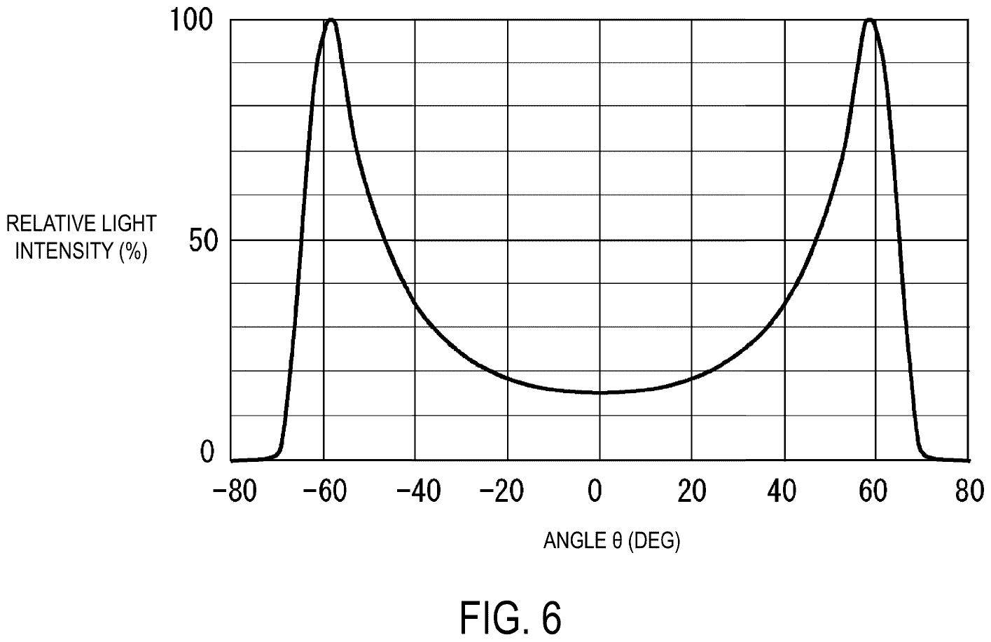

FIG. 6 shows an example of a batwing intensity distribution. In the example in FIG. 6, the angle of view θ_{FOI} is 120° (±60°). Note that, to obtain a batwing intensity distribution, it is necessary to adjust each parameter in the mathematical expression (1) to suppress the amount of light passing through each of the lens elements 1a in the front direction and increase the amount of light passing through the wide angle region where the angle θ from the optical axis is great. For example, to uniformly irradiate the screen in the range of the angle of view θ_{FOI}=120°, the intensity of the light passing in the direction of ±60° may be set to about eight times the intensity of the light passing in the front direction of θ=0°.

In the present embodiment, the pitch D between the lens elements 1a is in a range of 25 μm or greater and 150 μm or less. In this way, the appearance of the interference fringes illustrated in FIG. 3(a) and the moire fringes illustrated in FIG. 3(c) is suppressed. This makes it possible to obtain a sufficiently uniform and sharp profile of the irradiance distribution on the screen 3 even when the randomization rate is 3% or less.

### Batwing Curve

Note that, in the description above, the irradiance distribution is made uniform by causing the intensity distribution of the light that has passed through the micro lens array 1 to have a so-called batwing intensity distribution. The intensity distribution of the light that has passed through the micro lens array 1 within the angle of view θ_{FOI} at that time may be set as an intensity distribution in accordance with

I=αCOS⁻ⁿθ+β (2).

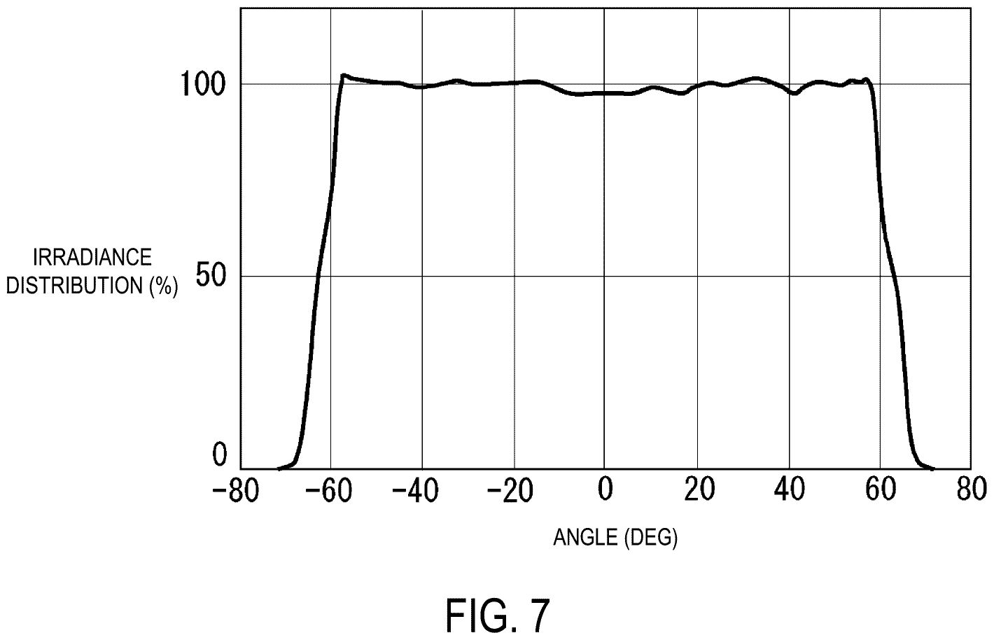

Note that α is a proportionality constant, and β is a value of an intercept. n is a numerical value in a range of 1 to 10. In this way, in the angle of view θ_{FOI}, the intensity distribution of the light that has passed through the micro lens array 1 is in accordance with the expression (2), and thus the irradiance distribution in the range corresponding to the angle of view θ_{FOI} on the screen 3 can be more reliably made uniform. FIG. 7 shows the irradiance distribution on the screen 3 when the intensity distribution of the light that has passed through the micro lens array 1 within the angle of view θ_{FOI} is in accordance with the expression (2) when the angle of view θ_{FOI} is 120°. It can be seen that the irradiance distribution exhibits excellent uniformity within the angle of view θ_{FOI}.
Relationship between Batwing Curve, and R and D

In the present embodiment, to cause the intensity distribution of the irradiation light that has passed through the micro lens array 1a to be a batwing intensity distribution, the amount of light passing through the vicinity of the apex of each of the lens elements 1a is made relatively small, and the amount of light passing through a portion corresponding to a base of each of the lens elements 1a is made relatively great as described above. In the shape of each of the lens elements 1a, it is necessary to appropriately set a relationship between the pitch D and R at the apex to relatively reduce the region where R at the apex is maintained and relatively increase the region corresponding to the base.

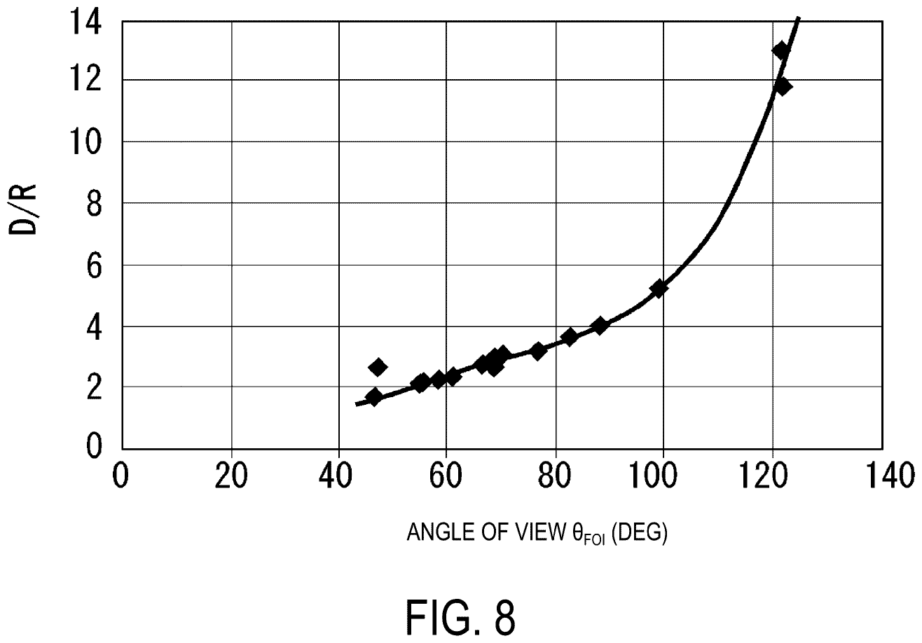

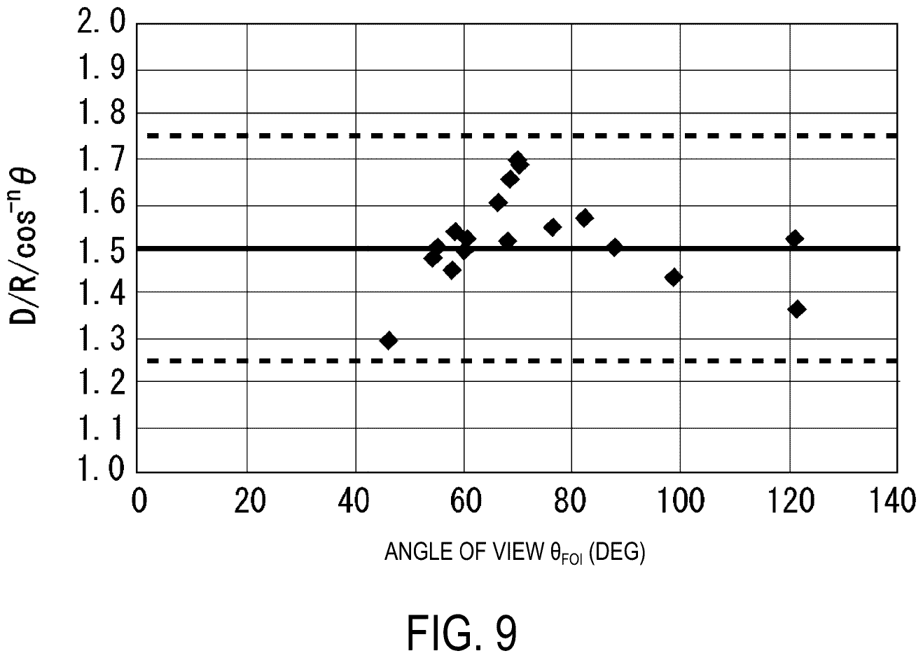

To maintain the uniformity of the irradiance distribution when the angle of view θ_{FOI} is further increased, as shown in FIG. 8, it is necessary to increase a value of D/R as the angle of view θ_{FOI} is relatively increased. As described above, in the present embodiment, as shown in FIG. 9, the pitch D between the lens elements 1a and the diameter R at the apex may be set, and thus a value of D/R/COS⁻ⁿθ falls within a range of

D/R/COS⁻ⁿθ=1.5±25% (3)

regardless of the value of the angle of view θ_{FOI}. In this way, even when the angle of view θ_{FOI} is set to be great, the uniformity of the irradiance distribution on the screen 3 of the light that has passed through the micro lens array 1 can be more reliably ensured. Note that, also in this case, a range of n may be n=0 to 10, and more preferably n=1 to 7.

As described above, in the present embodiment, the requirements for improving the uniformity of the irradiance distribution on the screen 3 of the light that has passed through the lens elements 1a of the micro lens array 1 include as follows.
1. The lens surface shape of the lens elements 1a is made to be an aspherical shape as indicated in the expression (1), for example.
2. The pitch D between the lens elements 1a is set to D=25 μm or greater and 150 μm or less.
3. The intensity distribution of the irradiation light passing through the micro lens array 1 is set to have a batwing shape in accordance with the expression (2).
4. A value of D/R is determined to satisfy the expression (3).
   The points above are mentioned.

However, the batwing shape does not necessarily need to be a curve according to the expression (2). The uniformity of the irradiance distribution on the screen 3 can be made sufficiently with the curve in which the light intensity at the end portion of the angle of view θ_{FOI} is maximized and the light intensity at the center portion of the angle of view θ_{FOI} (in the optical axis direction of the micro lens array 1) is minimized.

The relationship between the batwing curve, and R and D does not necessarily need to satisfy the expression (3). By setting the relationship between R and D in which the value of D/R increases as the angle of view θ_{FOI} relatively increases, the uniformity of the irradiance distribution on the screen 3 can sufficiently be increased.

In the present embodiment, it has been described that the randomization rate of each of the lens elements 1a can be set to 3% or less by setting the pitch D between the lens elements 1a in the range of 25 μm or greater and 150 μm or less. However, the randomization rate can be further increased according to the use of the micro lens array 1. For example, the randomization rate of each of the lens elements 1a may be 20% or less. More preferably, the pitch D between the lens elements 1a is in a range of 35 μm or greater and 125 μm or less, and even more preferably in a range of 50 μm or greater and 100 μm or less, and thus the appearance of interference fringes and moire fringes can more reliably be suppressed and the uniformity of the irradiance distribution can be increased.

A specific value of the radius R at the apex of the lens elements 1a of the micro lens array 1 in the present embodiment may be 3 μm or greater and 60 μm or less. Preferably, the value may be from 3 μm to 10 μm. In this case, when the pitch D between the lens elements 1a is in the range of 25 μm or greater and 150 μm or less and the angle of view θ_{FOI} exceeds 100° (±50°), the irradiance distribution can be sufficiently uniform by setting θ of the base portion of the lens elements 1a to about 75°.

In the present embodiment, the case has been described in which the light emitted from the light source 2 passes through the micro lens array 1 to increase the irradiation distribution of the light that has passed. However, the micro lens array 1 can also be used such that the light emitted from the light source 2 is reflected on the micro lens array 1 and then projected on the screen 3.

In the present embodiment, the case has been described in which the lens elements 1a on the micro lens array 1 are arrayed on one side that is a side close to the light source 2, but those may also be arrayed on one side that is an opposite side from the light source 2. Furthermore, the lens elements may be arrayed on both sides.

The lens elements 1a have a cross-sectional shape defined by the aspherical shapes discontinuously arranged, but they may also have a shape defined with aspherical shapes continuously connected via smooth curved lines.

Furthermore, regarding the material of the micro lens array 1 in the present embodiment, the substrate and the lens elements 1a may be formed by different materials, or may be integrally formed of the same material. When the substrate and the lens elements 1a are formed by different materials, one of the substrate and the lens elements 1a may be formed by a resin material, and the other one may be formed by a glass material. When the substrate and the lens elements 1a are integrally formed with the same material, the transmission efficiency can be improved due to the absence of a refractive index interface. Furthermore, such a configuration is free of peeling between the substrate and the lens elements 1a and thus can achieve a high reliability. In this case, the micro lens array 1 may be formed by resin only, or may be formed by glass only.

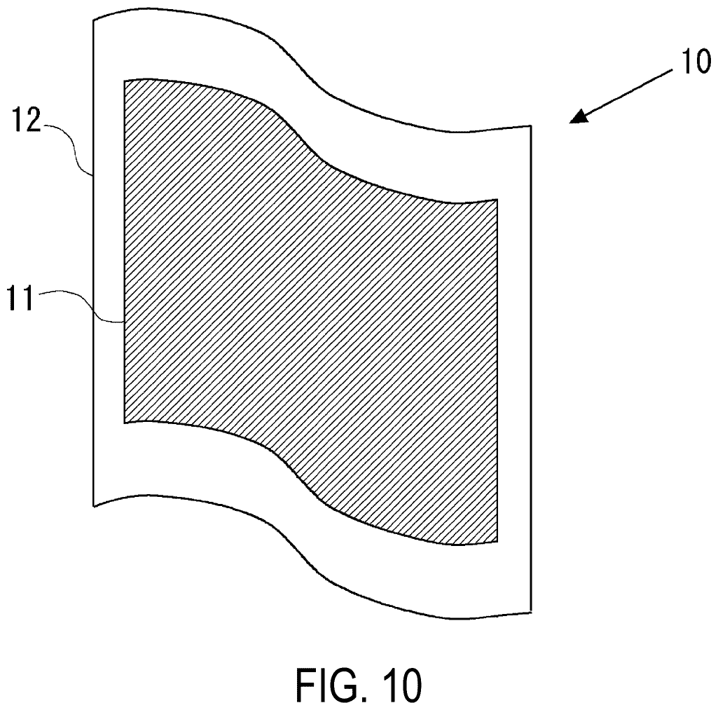

As illustrated in FIG. 10, a micro lens array 11 having the same function as the micro lens array 1 described in the present embodiment may be formed on a flexible sheet 12, thereby forming a diffuser plate 10 that diffuses and uniformizes the incident light. It is obvious that the micro lens array 11 can be formed on a rigid flat plate, to obtain a diffuser plate.

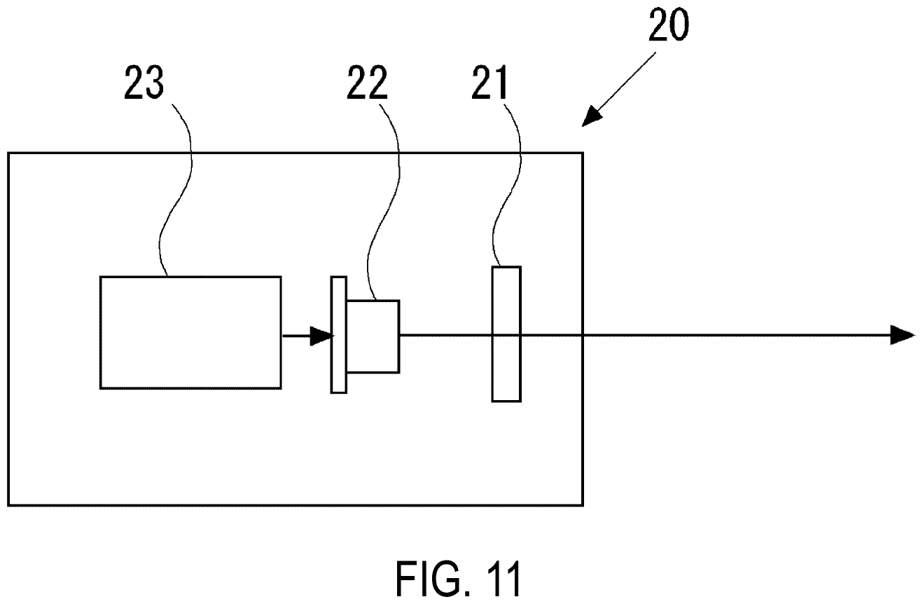

Furthermore, as illustrated in FIG. 11, a micro lens array 21 having the same functions as the micro lens array 1 described in the present embodiment, a light source 22, and a light source control unit 23 may be combined to form an illumination apparatus 20. The illumination apparatus 20 may be used alone for illumination, or may be incorporated into a measuring apparatus such as distance measuring equipment using the TOF system or other apparatuses. Also, in the illumination apparatus 20, the lens elements of the micro lens array 21 may be arranged on one side that is on the light source 22 side, or may be arranged on one side that is an opposite side from the light source 22. The lens elements may be arranged on both sides. Furthermore, the light source 22 with directivity of ±20° or less may be used. More preferably, the light source 32 with directivity of ±10° or less may be used. When the light source 22 with high directivity is used, the irradiance distribution at both ends of the angle of view θ_{FOI} can be shaped to be more edgy.

Note that a micro lens array having a function equivalent to that of the micro lens array 1 described in the present embodiment may be used as an optical system for image capturing, face authentication in security equipment, or space authentication in vehicles or robots.

### Other Aspherical Shapes

In the above-described embodiment, the example in which the sag amount Z of the lens elements 1a of the micro lens array 1 is defined by the normal aspherical expression (1) is described. However, the shape of the lens elements 1a is not limited to the above example. For example, the shape of the lens elements 1a may be a shape in which the sag amount Z is in accordance with the following Zernike polynomial (4).

$$[ Math . 3 ]$$

$$Z = \frac{{Cr}^{2}}{1 + \sqrt{( 1 + K ) {C}^{2} {r}^{2}}} + {\sum }_{n = 1}^{66} Cn + 1 Zn \qquad ( 4 )$$

Note that C is a curvature at the apex of each of the lens elements 1a (C=1/R), K is a conic coefficient, r=√(X²+Y²) (X and Y are X and Y coordinates in orthogonal coordinates with the optical axis of each of the lens elements 1a as the origin), Cₙ₊₁ is a coefficient of Zₙ, and Zₙ is an n-th order Zernike polynomial (n=1 to 66).

Alternatively, the shape of the lens elements 1a may be a shape in which the sag amount Z is in accordance with the following XY polynomial (5).

$$[ Math . 4 ]$$

$$Z = \frac{{Cr}^{2}}{1 + \sqrt{1 + ( 1 + K ) {C}^{2} {r}^{2}}} + {\sum }_{j = 2}^{66} {C}_{j} {X}^{m} {Y}^{n}$$

Note that C is a curvature at the apex of each of the lens elements 1a (C=1/R), K is a conic coefficient, r=√(X²+Y²) (X and Y are X and Y coordinates in orthogonal coordinates with the optical axis of each of the lens elements 1a as the origin), Cⱼ is a coefficient of a polynomial X^{m}Yⁿ, and j=[(m+n)²+m+3n]/2+1.

### Wiring of Conductive Substance

Wiring including a conductive substance may be provided on the surface of or inside the micro lens array 1 according to the present embodiment, and thus by monitoring the conducting state of the wiring, a damage on each lens elements 1a may be detected. With this configuration, a damage such as crack or peeling of each of the lens elements 1a can be easily detected. Thus, a problem caused by a failure and malfunctioning of an illumination apparatus or distance measuring equipment due to the damaging of the micro lens array 1 can be prevented in advance. For example, when the occurrence of a crack formed in the lens elements 1a is detected by disconnection of the conductive substance, emission of light from the light source may be stopped, and thus 0th order light from the light source can be prevented from directly passing through the micro lens array 1 through the crack and being emitted to the outside. As a result, the eye safety performance of the apparatus can be improved.

The wiring of the conductive substance described above can be provided around the micro lens array 1 or on each of the lens elements 1a. The wiring may also be provided on a surface on which the lens elements 1a are formed, a surface opposite to such a surface, or both surfaces. The electrically conductive substance is not particularly limited as long as it has electrical conductivity, and for example, metal, metal oxide, electrically conductive polymer, electrically conductive carbon-based substance, or the like can be used.

More specifically, the metal include gold, silver, copper, chromium, nickel, palladium, aluminum, iron, platinum, molybdenum, tungsten, zinc, lead, cobalt, titanium, zirconium, indium, rhodium, ruthenium, alloys thereof, and the like. Examples of the metal oxide include chromium oxide, nickel oxide, copper oxide, titanium oxide, zirconium oxide, indium oxide, aluminum oxide, zinc oxide, tin oxide, or composite oxides thereof such as composite oxides of indium oxide and tin oxide (ITO) and complex oxides of tin oxide and phosphorus oxide (PTO). Examples of the electrically conductive polymer include polyacetylene, polyaniline, polypyrrole, and polythiophene. Examples of the electrically conductive carbon-based substance include carbon black, SAF, ISAF, HAF, FEF, GPF, SRF, FT, MT, pyrolytic carbon, natural graphite, and artificial graphite. These electrically conductive substances can be used alone, or two or more types thereof can be used in combination.

The electrically conductive substance is preferably metal or metal oxide having excellent electrical conductivity and easy to form wire, and more preferably metal. Gold, silver, copper, indium, or the like is preferred, and silver is preferred because it is mutually fused at a temperature of approximately 100° C. and can form wire with excellent electrical conductivity even on the micro lens array 1 made of resin. A pattern and a shape of the wiring of the conductive substance is not particularly limited. A pattern surrounding the micro lens array 1 may be used, or a pattern with a more complicated shape may be used for the sake of higher detectability for the crack or the like. A pattern covering at least part of the micro lens array 1 by a permeable conductive substance may be used.

### REFERENCE SIGNS LIST

1, 11, 21 Micro lens array
1a Lens element
b Base material
2 Light source
3 Screen
10 Diffuser plate
12 Flexible sheet
20 Illumination apparatus
22 Light source
23 Light source control unit
100 TOF distance measuring equipment
101 Light source control unit
102 Light source
103 Irradiation optical system
104 Reflection optical system
105 Light receiving element
106 Signal processing circuit

1. A micro lens array comprising:
a plurality of lens elements arrayed on at least one surface of a planar member, wherein
a shape of a lens surface in each of the lens elements is defined by an aspherical expression,
a pitch D between the lens elements in the micro lens array is 25 μm or greater and 150 μm or less, and
an intensity distribution of light that passes through the micro lens array has a batwing intensity distribution in which light intensity at both ends in a predetermined range of an angle of view is maximized and light intensity at the center in the range of the angle of view is minimized.

2. The micro lens array according to claim 1, wherein
the batwing intensity distribution has a distribution characteristic along a curve of COS⁻ⁿθ (n=0 to 10) for an angle θ of the lens element with respect to an optical axis direction.

3. The micro lens array according to claim 1, wherein
a radius R at an apex of the lens element is 3 μm or greater and 60 μm or less.

4. The micro lens array according to claim 1, wherein
a radius Rat an apex of the lens element, a pitch D between the lens elements, and an angle θ of the lens element with respect to an optical axis direction have a relationship of D/R/COS⁻ⁿθ=1.5±25%.

5. The micro lens array according to claim 1, wherein
a sag amount Z in the lens element satisfies
$$[ Math . 1 ]$$
$$Z = \frac{{C}_{X} {X}^{2} + {C}_{Y} {Y}^{2}}{1 + \sqrt{1 - ( 1 + {K}_{X} ) {C}_{X}^{2} {X}^{2} - ( 1 + {K}_{Y} ) {C}_{Y}^{2} {Y}^{2}}} + {\sum }_{n = 2}^{10} {{A}_{2 n} [ ( 1 - {B}_{2 n} ) {X}^{2} + ( 1 + {B}_{2 n} ) {Y}^{2} ]}^{n} .$$

6. The micro lens array according to claim 1, wherein
a randomization rate in the plurality of lens elements is ±20% or less.

7. The micro lens array according to claim 1, wherein
the micro lens array is formed integrally of a same material.

8. The micro lens array according to claim 1 comprising:
wiring including a conductive substance.

9. The micro lens array according to claim 8, wherein
the wiring is formed on surfaces of the lens elements or around the lens elements.

10. A diffuser plate using the micro lens array according to claim 1.

11. An illumination apparatus comprising:
the micro lens array according to claim 1; and
a light source configured to emit light incident on the micro lens array.

12. The illumination apparatus according to claim 11, wherein
the lens elements of the micro lens array are arrayed on a surface on a side close to the light source.

13. The illumination apparatus according to claim 11, wherein
the directivity of the light source is ±20° or less.

14. The illumination apparatus according to claim 11, wherein
the light source is a laser light source configured to emit near-infrared light.

15. The illumination apparatus according to claim 11, wherein
the illumination apparatus is used in distance measuring equipment.

16. The micro lens array according to claim 2, wherein
a radius R at an apex of the lens element is 3 μm or greater and 60 μm or less.

17. The micro lens array according to claim 2, wherein
a radius Rat an apex of the lens element, a pitch D between the lens elements, and an angle θ of the lens element with respect to an optical axis direction have a relationship of D/R/COS⁻ⁿθ=1.5±25%.

18. The micro lens array according to claim 2, wherein
a sag amount Z in the lens element satisfies
$$[ Math . 1 ]$$
$$Z = \frac{{C}_{X} {X}^{2} + {C}_{Y} {Y}^{2}}{1 + \sqrt{1 - ( 1 + {K}_{X} ) {C}_{X}^{2} {X}^{2} - ( 1 + {K}_{Y} ) {C}_{Y}^{2} {Y}^{2}}} + {\sum }_{n = 2}^{10} {{A}_{2 n} [ ( 1 - {B}_{2 n} ) {X}^{2} + ( 1 + {B}_{2 n} ) {Y}^{2} ]}^{n} .$$

19. The micro lens array according to claim 2, wherein
a randomization rate in the plurality of lens elements is ±20% or less.

20. The micro lens array according to claim 2, wherein
the micro lens array is formed integrally of a same material.
